(19) United States
(12) Patent Application Publication
(10) Pub. No.: US 2002/0103933 A1
(43) Pub. Date: Aug. 1, 2002

(54) Internet-access enabled device personalization

(76) Inventors: Ross Garon, New York, NY (US); David Siegel, New York, NY (US)

Correspondence Address: MORGAN & FINNEGAN, L.L.P., 345 Park Avenue, New York, NY, 10154, US

(21) Appl. No.: 09/770,298

(22) Filed: Jan. 29, 2001

(51) Int. Cl. G06F 15/16

(52) U.S. Cl. 709/246

(57) ABSTRACT

A system and method are disclosed for quickly and automatically personalizing an Internet-access enabled device based upon a user's pattern of behavior or express preferences on other, possibly incompatible, Internet-access enabled devices. The system and method enable a user to create a personal profile on a first Internet-access enabled device. This profile comprises URLs in the form of bookmarks, a history file, express preferences, or common behaviors derived from a list of URLs. The profile can also include other indicators of preference, such as browser cookies, log files, or the like.

### CROSS-REFERENCE TO RELATED APPLICATIONS

This application is related to copending PCT Application 00/04588, entitled “Synergistic Internet Bookmarks Combining Internet Searching and Hot Linking” and filed on Feb. 23, 2000 with the U.S. designated as receiving office, the entirety of which is incorporated herein by reference. PCT 00/04588 claims the benefit of priority of U.S. provisional patent application serial number 60/125,048, entitled “Synergistic Internet Bookmarks Combining Internet Searching and Hot Linking” and filed on Mar. 18, 1999, the entirety of which is incorporated herein by reference.

### TECHNICAL FIELD

The present system and method relates generally to quickly and automatically personalizing an Internet-access enabled device based upon a user's pattern of behavior or express preferences on other, possibly incompatible, Internet-access enabled devices.

### BACKGROUND

As the Internet has matured, the amount of information available has grown dramatically and has increased the difficulty of finding information relevant to a particular topic of interest. The Internet is essentially a collection of linked content pages that can be imagined to resemble a spider's web. The usefulness of the web is to a large extent determined by how easily information stored in one place can be located by someone in another. Information stored on a Web page is typically accessed through a program called a web browser (e.g., Netscape Navigator, Microsoft Internet Explorer, Phone.com microbrowser, or the like) via a “Universal Resource Locator” or “URL”. The URL is commonly referred to as a “web address”, a “hyperlink”, or simply a “link”. An example of a URL is http://www.blink.com/. When a URL is entered into the browser on a local computer, such as a desktop Macintosh or DOS system, the browser connects to a web server and displays a particular page of content associated with that URL. Web pages can further include embedded hyperlinks that, when selected (e.g., by clicking with a mouse), will link with the page corresponding to the hyperlink URL.

Additionally, most browsers have a mechanism that allows the user to manually save the addresses of preferred web pages as “bookmarks”, “favorites”, or the like. Typically, when users navigate the web and find a web page of interest, the user will “bookmark” the site, or add the URL to the user's “favorites”, so that the user can easily return to the site via the bookmark without having to search for or retype the URL.

With the explosive increase in Internet usage, an increased number of computer devices with Internet-access capability have been created. Devices such as wireless web phones, personal data assistants (PDAs), and other mobile devices with modemesque capabilities are at the forefront of the wireless Internet revolution. However, in comparison to a full function personal computer, these Internet-access capable devices are often limited by memory, bandwidth, connection, screen size, keyboard size, or the like. In response, many websites or companies offer several versions of their websites; each targeted specifically to certain, or several, of these devices. The websites often utilize HyperText Markup Language (HTML), but may be in different markup languages.

In order to address the limitations of such Internet-access capable devices, several websites have created wireless counterpart websites that substantially mirror the standard HTML site (e.g. www.google.com has a mirror site at wap.google.com). However, with the number of websites available on the web increasing exponentially, many websites have not developed mirror sites for browsers other than standard HTML browsers.

Along with the increasing number of websites, there are an increasing number of devices for accessing the Internet, many of which have limited capabilities. In many cases, a site is available in standard HTML that offers an equivalent for alternative devices, especially wireless devices. However, there is a need to identify these wireless or non-HTML pages. Therefore the personalization of devices, especially wireless Internet-access capable devices, will enable users to get the same experience from any device that they use to access the web.

### SUMMARY

A system and method are disclosed herein for quickly and automatically personalizing an Internet-access enabled device based upon preferences or a user's pattern of behavior on other, possibly incompatible, Internet-access enabled devices. In various embodiments, the present system, program, and method enable a user to create a personal profile on one Internet-access enabled device. This profile comprises URLs in the form of bookmarks, a history file, preferences, or common behaviors derived from a list of URLs. The profile may also include other indicators of preference, such as browser cookies, log files, or the like. Further, the personalization of the Internet device may be based upon a user's expressed preferences, which the user can provide in order to have a set of bookmarks customized for them. The program software is downloaded to that device or runs over the Internet. The information can be transferred via the web to a central database.

A system program (that may be web-based or run locally on the user's device) contacts the central database and consults a table mapping the user's profile to a list of URLs that are available on, or compatible with, a second Internet-access enabled device. When the user initiates connection to the user's account on a second Internet-access enabled device, a list of services is thus available to the second Internet-access enabled device, in which the user may be interested. The list is downloaded to that device or made available on a dynamically created page via the Internet.

A specific application involves a web-enabled phone and an Internet-access enabled computer. A user utilizes the program to open an account and upload bookmarks from the user's computer to a central database. The user then logs into a web page from the user's phone and displays a list of similar bookmarks to pages specially formatted for wireless devices. For example, if the user had bookmarked www.google.com from the user's computer, the wireless web-enabled phone page displays wap.google.com.

In one embodiment, a method is disclosed for managing network address bookmarks for a variety of browser types in computers in a network. The method is performed on a server. The server receives a first network address bookmark at a server from a first computer having a first type browser. The first bookmark has a first format suitable for the first type browser. The method next receives a characterization at the server of a second computer having a second type browser and translates the first bookmark at the server into a second network address bookmark having a second format suitable for the second type browser. The second bookmark can then be sent to the second computer. The first type browser in this embodiment can be different from the second type browser.

The translation of the first bookmark into a second bookmark of this embodiment can further include transmitting a trial message on the network from the server using the second network address bookmark, receiving at the server a response to the transmitting step from the network, and determining from the response whether the second network address exists in the network. Alternatively, the translation includes searching a database of candidate bookmarks for the second network address bookmark and determining from results of the searching step whether the second bookmark is valid.

Another embodiment of the method receives at a server, from a user at a computer, a first network address bookmark having an interest category. The method then accesses with the server a database of candidate bookmarks associated with the interest category, forms a list including a portion of the candidate bookmarks obtained from the accessing step, and sends the list of bookmarks to the user's computer.

Another embodiment of the method receives a first user profile at a server, from a first user at a first computer, the first user profile including an interest category. The method then accesses with the server a database of candidate bookmarks associated with the interest category, forms a list including a portion of the candidate bookmarks obtained from the accessing step, and sends the list of bookmarks to the computer. The first user profile in this embodiment includes a history log of the computer from which the method determines a second interest category. The method then accesses with the server a database of candidate bookmarks associated with the second interest category and augments the list with a portion of the candidate bookmarks obtained from the accessing step and sends the augmented list of bookmarks to the computer.

Another embodiment of the method receives a first user profile at a server, from a first user at a first computer, the first user profile includes browser cookie data of the user's computer. The method determines, from the browser cookie data, a second interest category and accesses with the server a database of candidate bookmarks associated with the second interest category. The method then augments the list with a portion of the candidate bookmarks obtained from the accessing step and sends the augmented list of bookmarks to the computer.

Alternatively, the first user profile includes demographic data of the user and the method determines from the demographic data a second interest category and accesses with the server a database of candidate bookmarks associated with the second interest category. The method then augments the list with a portion of the candidate bookmarks obtained from the accessing step and sends the augmented list of bookmarks to the computer.

A further embodiment includes receiving, at a server from a first computer, interest data having a first format. The server then receives a characterization of a second computer having a second format, compiles a first set of bookmarks in the first format based upon the interest data, and compiles a second set of bookmarks in the second format based upon the first set of bookmarks. The server can then send the second set of bookmarks to the second computer.

A further embodiment includes receiving, at a server from a first computer, interest data having a first format compatible with the first computer. The server then receives a characterization of a second format compatible with a second computer, accesses a database containing bookmarks having the first format, retrieves a first bookmark having the interest data, and translates the first bookmark into a second bookmark in the second format.

A further embodiment includes receiving, at a server from a first computer, interest data having a first format compatible with the first computer. The server then receives a characterization at the server of a second format compatible with a second computer, accesses a first database containing bookmarks having the first format, retrieves a first bookmark in the interest data, accesses a second database containing bookmarks having the second format, and selects a bookmark from the second bookmarks in the interest data.

### BRIEF DESCRIPTION OF THE DRAWINGS

The foregoing and other features and advantages will become more apparent in light of the following detailed description of exemplary embodiments thereof, as illustrated in the accompanying drawings.

FIG. 1 is a system flow diagram of the sequence of operative steps of three different nodes of the network shown in FIGS. 2A, 2B, and 3.

FIG. 2A is a network diagram showing an example relationship between the user's portable general wireless device 100, a general protocol gateway 140, and the server computer 110.

FIG. 2B is a network diagram showing an example relationship between the user's portable Wireless Application Protocol (WAP) wireless device 100, a WAP protocol gateway 140, and the server computer 110.

FIG. 3 is a network diagram illustrating the relationship between the user's portable wireless device, the user's desktop computer, and server computer as interconnected over the network.

FIG. 4A illustrates the public bookmarks database of the user as stored in the server.

FIG. 4B illustrates the personal bookmarks database of the user's profile as stored in the server.

FIG. 4C illustrates the bookmark folder database of multiple users as stored in the server.

FIG. 4D illustrates the express personal bookmarks database as stored in the server.

FIG. 5 is a network flow diagram illustrating an example of the sequence of operational steps carried out by the user's portable wireless device and the server computer during user login.

FIG. 6A is a functional block diagram for the server computer 110.

FIG. 6B is a flow diagram of the user visit object method 628.

FIG. 7 is a flow diagram showing Steps 36, 38, and 40 of FIG. 1 in greater detail.

### DETAILED DESCRIPTION

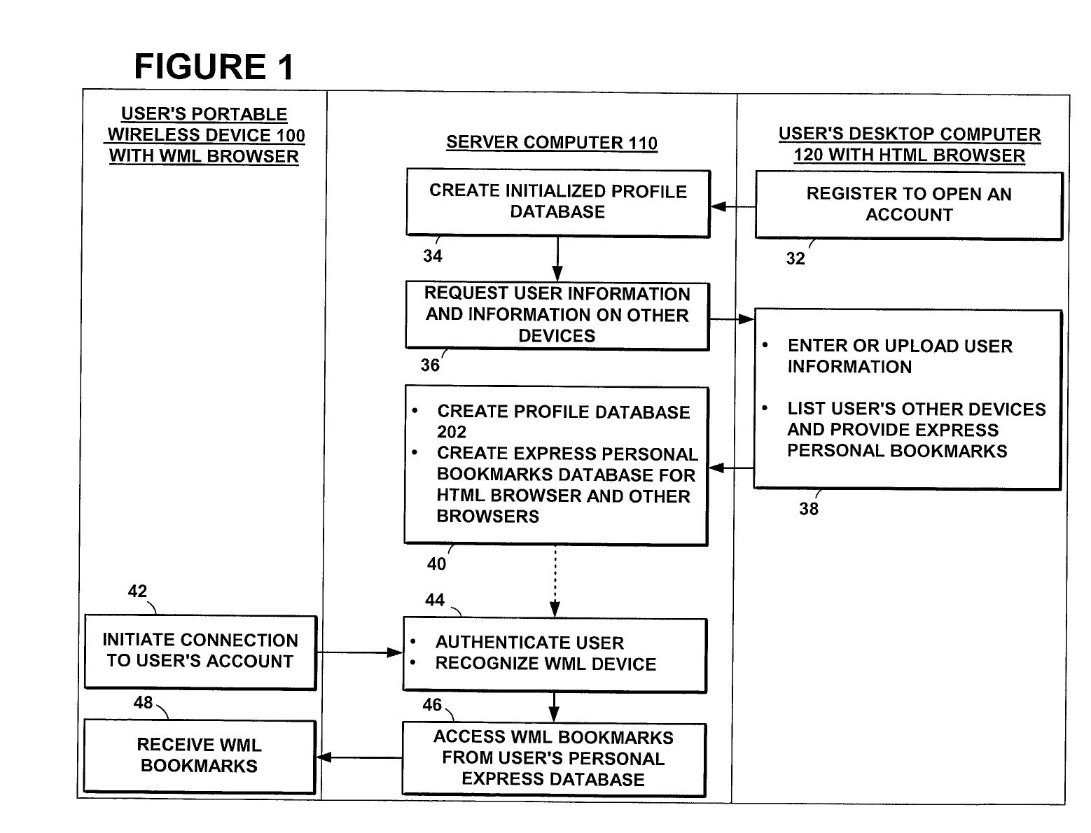

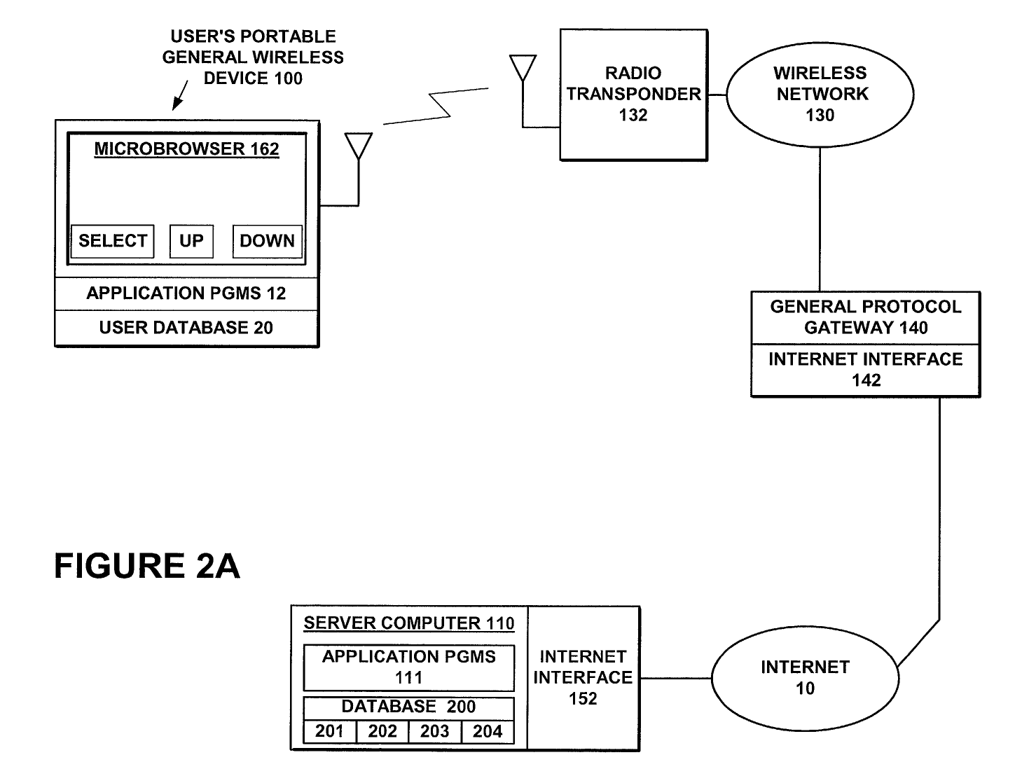

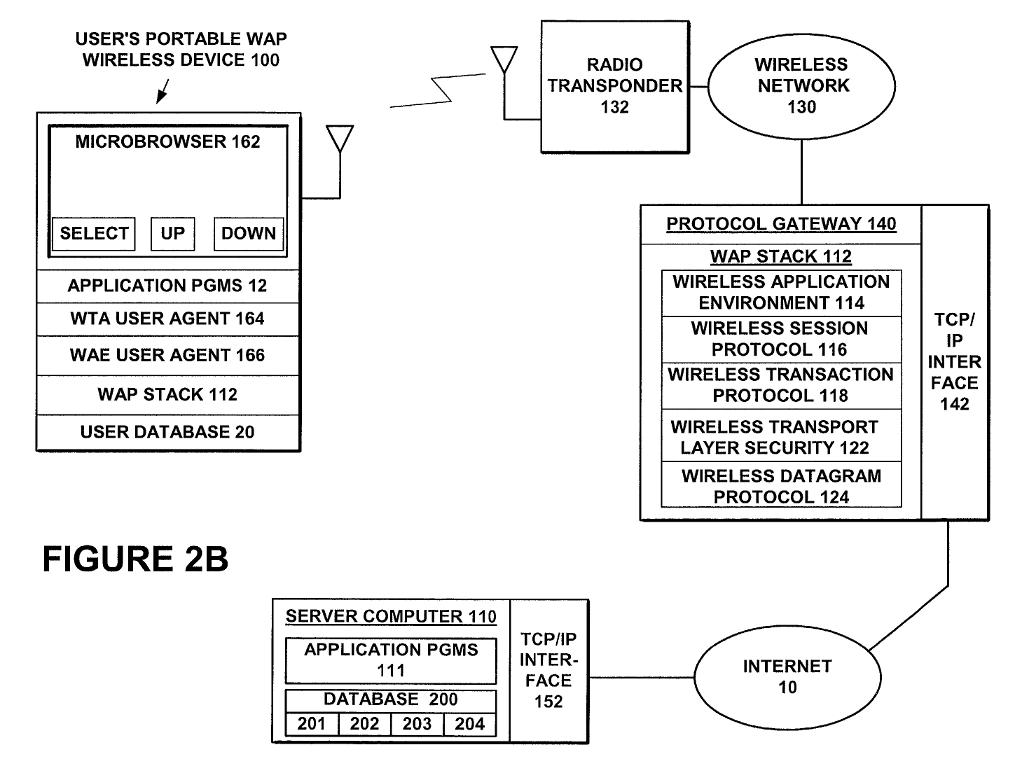

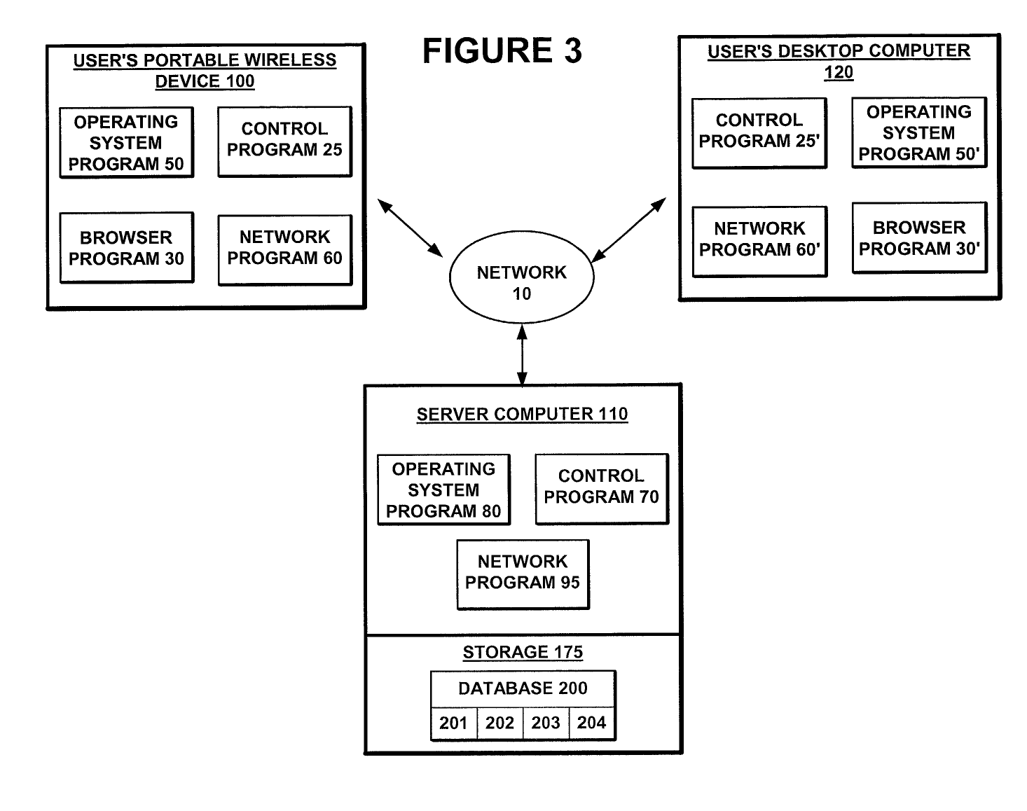

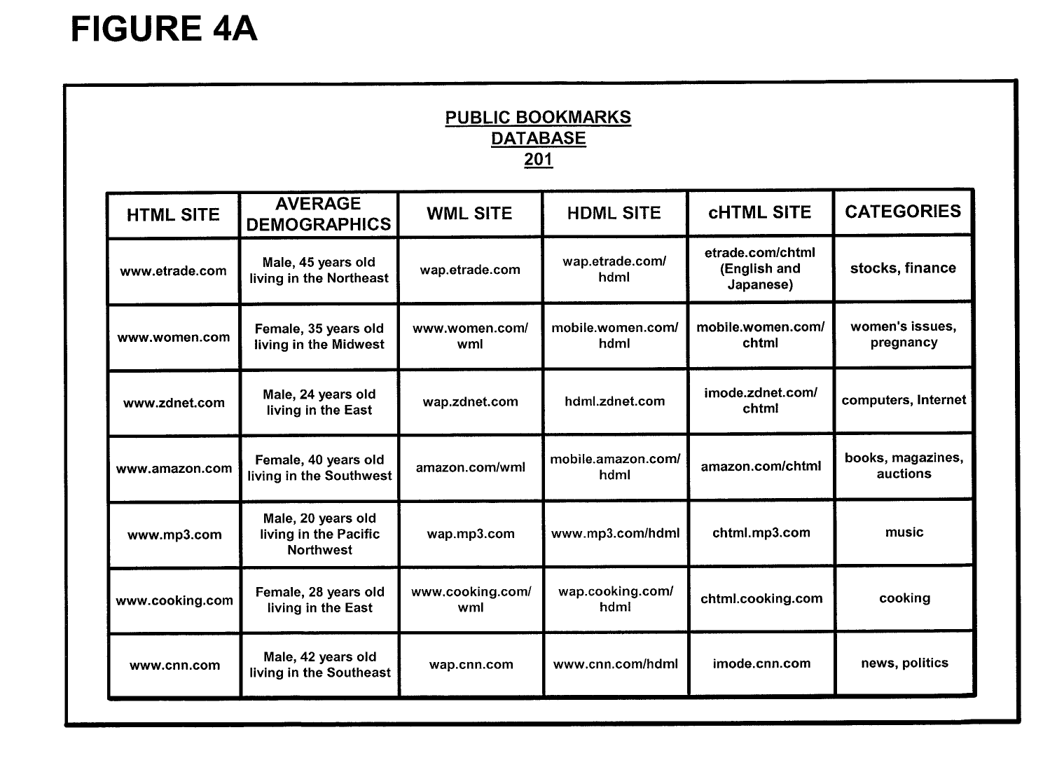

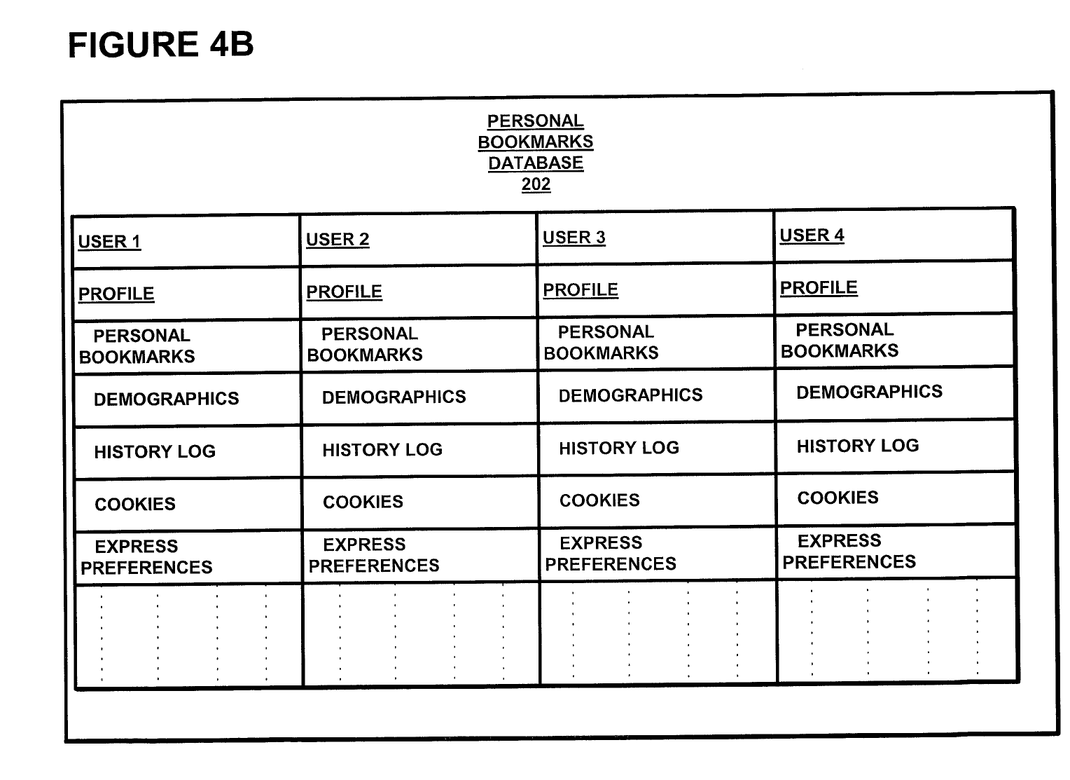

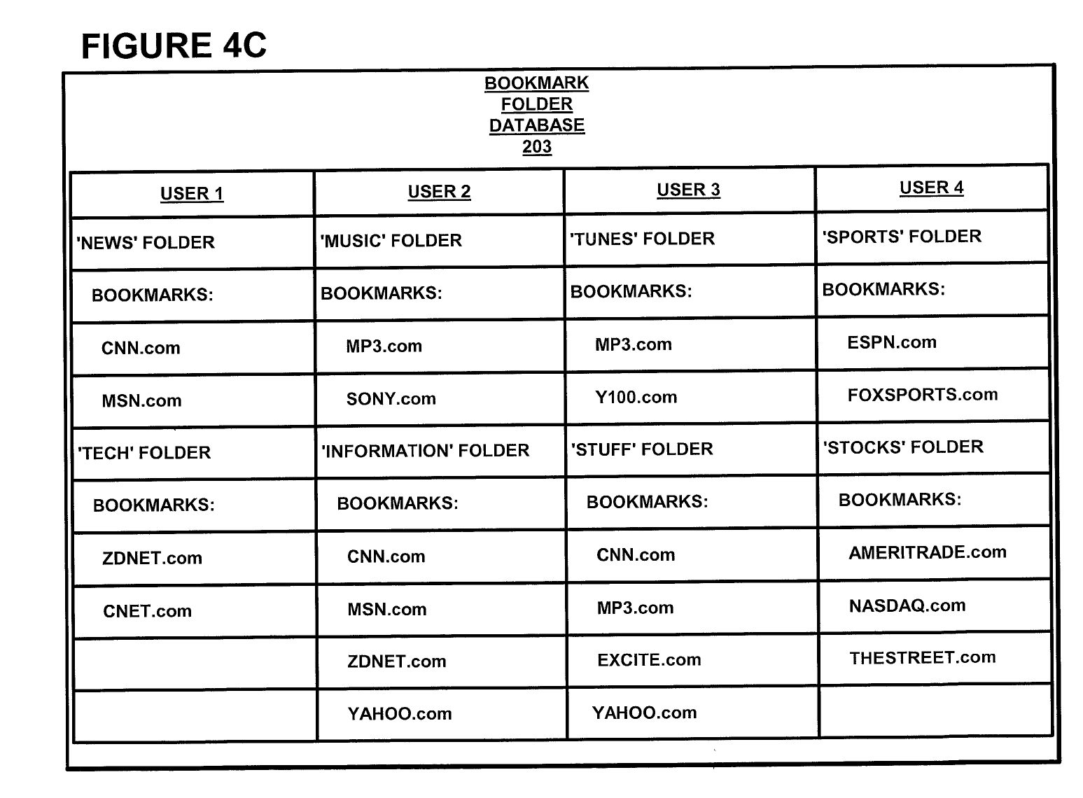

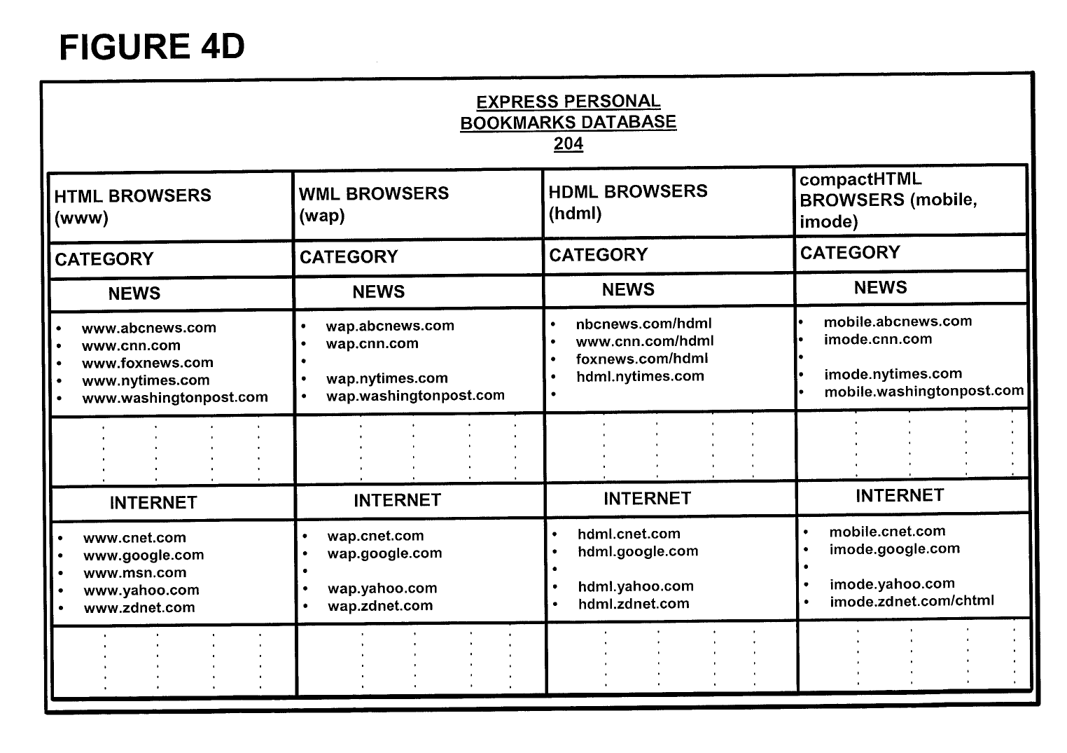

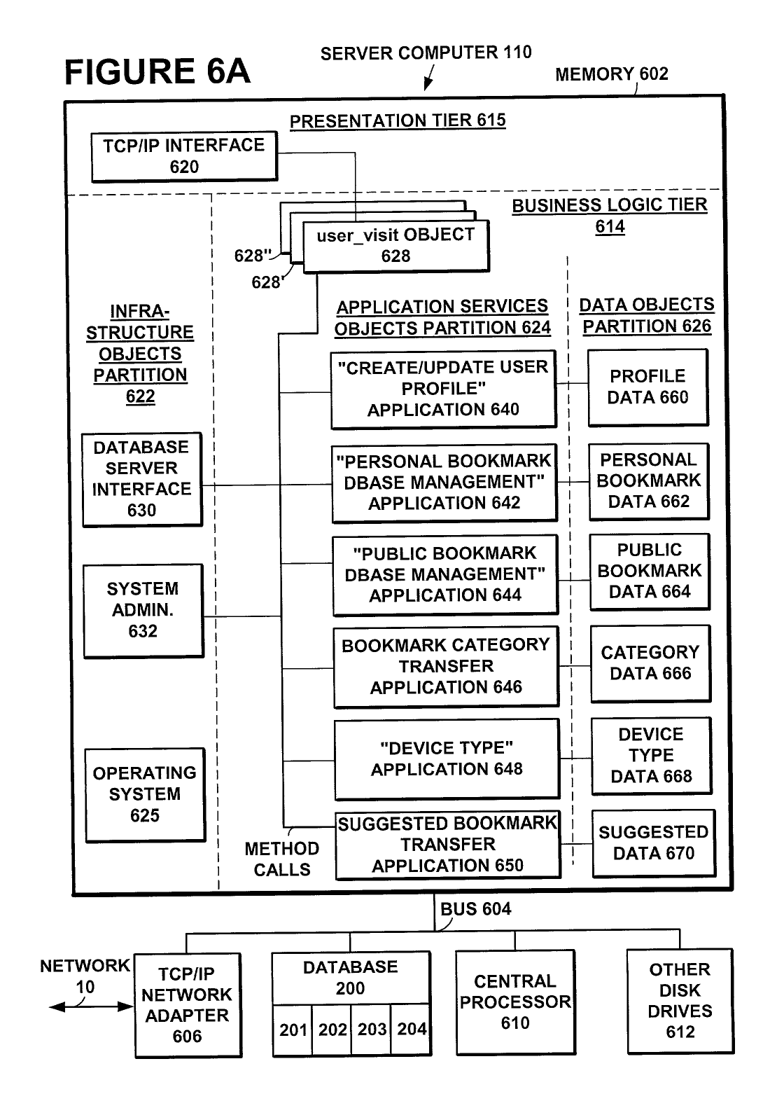

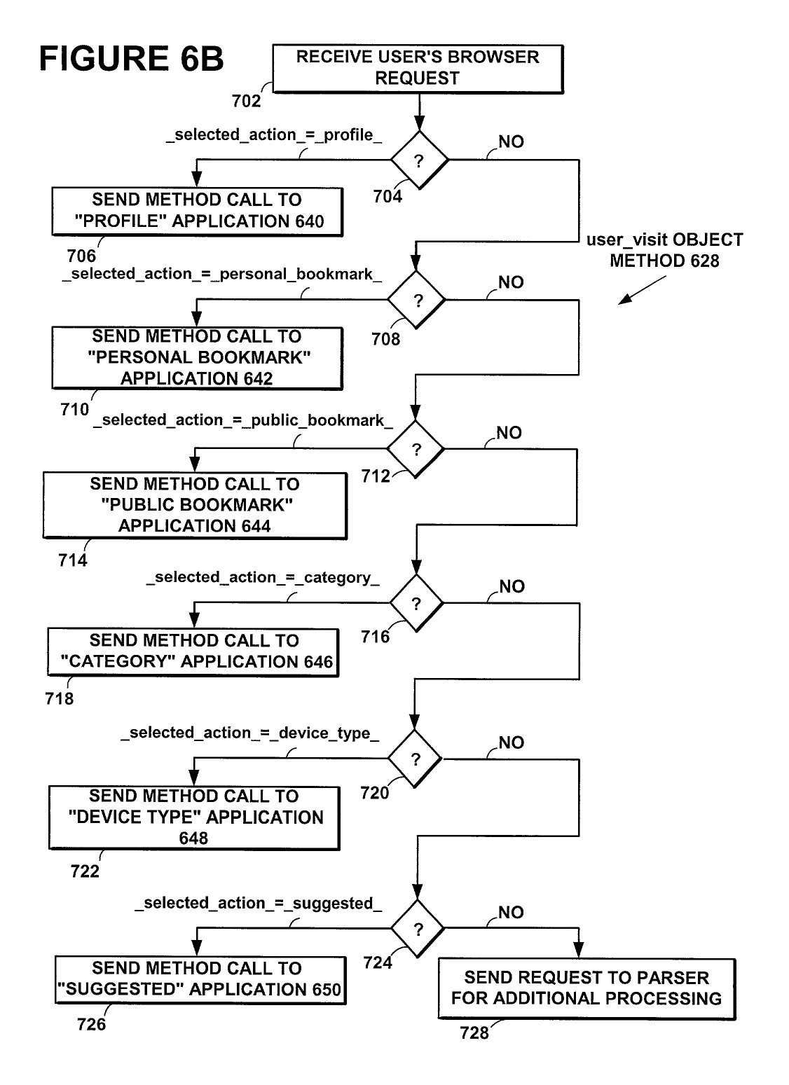

FIG. 1 is a system flow diagram of the sequence of operative steps of three different nodes of the network shown in FIG. 2A, FIG. 2B, and FIG. 3. The first node is the user's portable wireless device 100, represented by the left-hand column in FIG. 1, the second node is the server computer 110, shown in FIGS. 2A and 2B, which is represented by the center column in FIG. 1. The third column of FIG. 1 represents a third node, the user's desktop computer 120 shown in FIG. 3. The server computer 110 includes application programs 111 shown in FIG. 6A and database 200, which includes databases 201, 202, 203, and 204 shown in FIGS. 4A through 4D respectively.

In response to the user's desktop computer 120 registering to open an account in step 32 of FIG. 1, the server computer 110 opens an account for the user and creates an initialized profile database in step 34. An example profile database 202 is shown in FIG. 4B. In FIG. 1, the server computer 110 then proceeds to step 36 that requests information, in the form of a questionnaire, from the user and information on the user's other devices. The questionnaire includes questions about the user's personal characteristics, such as where the user lives, the user's occupation, and other demographic information. In addition in step 36, the questionnaire can include questions about the user's express preferences and categories of interest.

Then, in step 38 of FIG. 1, the user's desktop computer 120 receives the questionnaire and the user enters or uploads the requested information, including the user's other devices, express preferences, preferred categories, and/or express personal bookmarks. The user in the example shown in FIG. 1 has two computers: the first computer is desktop computer 120 with an HyperText Markup Language (HTML) browser that the user is currently operating and the second computer is a portable wireless device 100 with a Wireless Markup Language (WML) browser. The user enters the device type information for all of the user's computers in step 38 and then sends the requested information back to the server computer 110. In addition, the user's computer 120 can send the history log and the cookie file during this, or any, information entry or upload by the user.

Step 38 of FIG. 1 describes uploading bookmarks, user profiles, and/or characterization information on other devices that can be accomplished manually or automatically. To upload automatically, client program software can be downloaded to the device over the Internet. The program running on the first computer uploads the requested information, including the user's other devices, express preferences, preferred categories, and/or express personal bookmarks. The client program includes computer executable program code that is downloaded from the Internet or is provided on a CDROM, for example. The code enables requesting, by the client computer having a first type browser, of network address bookmarks for a variety of browser types in computers in a network. The client program includes code to send a first network address bookmark from the first computer to the server, the first bookmark having a first format suitable for the first type browser. The client program includes code to send a characterization to the server of a second computer having a second type browser. The client program includes code to cause the server to translate the first bookmark into a second network address bookmark having a second format suitable for the second type browser. The client program includes code to cause the server to send the second bookmark to the second computer. Additionally, the client program includes code to send a first user profile from the first computer to a server, where the first user profile includes an interest category. The client program includes code to cause the server to access a database of candidate bookmarks associated with the interest category, form a list including a portion of the candidate bookmarks obtained from the accessing step, and send the list of bookmarks to the first computer.

In step 40 of FIG. 1, the server computer 110 incorporates the user's information into profile database 202. In addition, the server computer 110 creates an express personal bookmarks database 204 for an HTML browser and other browsers. The user's desktop computer 120 normally has an HTML type browser, typically referred to as a World Wide Web (WWW) browser. The express personal bookmarks database 204 is shown in greater detail in FIG. 4D.

In step 40 of FIG. 1, the server computer 110 receives the user's information; including express preferences, preferred categories, and/or express personal bookmarks in the format of the HTML browser for the desktop computer 120. The server computer 110 takes the user's indicated list of other devices and translates the user's express personal bookmarks from the user's initial HTML browser format into the appropriate formats for each of the types of browsers in the user's specified list of other devices; as shown in the express personal bookmarked database 204 of FIG. 4D. In FIG. 1, the server evaluates each respective express personal bookmark for the HTML browser provided by the user and determines whether a corresponding link in the server's database exists with either a WML browser format, an Handheld Device Markup Language (HDML) browser format, and/or a compactHTML (cHTML) format. For each of the formats that are successfully discovered that correspond to each respective universal resource locator (URL) of the HTML browser, the server computer 110 enters the translated URL into the corresponding appropriate column of the express personal bookmarks database 204 in FIG. 4D.

In the example shown in FIG. 4D, the user has listed express personal bookmarks for the desktop computer 120 with an HTML browser as shown in the left-hand-most column. In addition, the user has specified in the response to the questionnaire that the user has three other types of computers; each with a different type browser. The user in the example shown in FIG. 4D specifies that in addition to the HTML browser of the desktop computer 120, the user has a Wireless Markup Language (WML) browser, which normally operates on WAP, for the user's portable wireless device 100. The user in FIG. 4D also has an HDML browser, and, furthermore, the user specifies another mobile computer device that uses a cHTML browser, which utilizes a mobile or imode protocol, such as a personal data assistant (PDA) or the like.

As is well known, a WML phone will have pages (alternatively known as a deck of cards) that are transmitted from the server using a website URL of, for example, wap.blink.com. An imode phone will transmit imode format pages from a server having a URL of, for example, imode.blink.com. Furthermore, a personal data assistant (PDA) or other mobile device that uses the mobile-type format for its pages transmitted from the webserver will have a webserver URL of, for example, mobile.blink.com. However, several URLs for corresponding websites use differing link designations. Thus, as shown in FIG. 4D, foxnews.com correlates to foxnews.com/hdml for a device with an HDML browser.

In FIG. 1, since the user has provided sufficient information to enable the server computer 110 to open the user's new account and initialize the user's profile database, the user can later access the server computer 110 via the user's portable wireless device 100. The user's portable wireless device 100 initiates connection to the user's account in step 42 to the server computer 110. In step 44, the server computer 110 authenticates the user and recognizes the browser type for the user's portable wireless device 100, which in this case is a WML device using WAP. The WML device requires a different format for pages of information to be transmitted from the server 110 back to the user's portable wireless device 100 than the format for the pages sent to an HTML browser, using WWW, such as the user's desktop computer 120. The express personal bookmarks database 204 as shown in FIG. 4D includes a WML browser column that provides the appropriate format for pages sent from the server computer 110 to the user's portable wireless device 100. In step 46 of FIG. 1, the server computer 110 accesses the WML bookmarks from the user's personal express database 204 in FIG. 4D and then transmits those WML bookmarks to the user's portable wireless device 100. In step 48 of FIG. 1, the user's portable wireless device 100 receives the WML bookmarks through the WAP protocol in the user's device 100. The user can then display or store the bookmarks according to the user's selection. Although FIG. 1 has been constructed in a conventional manner, where a user initiates contact with the server through a desktop computer and later through a portable wireless device, one of ordinary skill in the art will recognize that the initiation of contact with the server, and all other contact thereafter, can be performed with any combination of devices; all of which are envisioned herein, but have not been shown in detail.

In FIG. 2A, the user's portable general wireless device 100 includes a microbrowser 162 that displays control buttons “UP”, “DOWN”, and “SELECT”, to enable the user to navigate through the cards being displayed and to select options that are programmed by the application programs 12. The user's portable general wireless device 100 includes the user database 20 that stores the user's private data.

The sequence of operational steps carried out by the user's portable general wireless device 100 and the server 110 can involve communicating directly through radio transponder 132, wireless network 130, general protocol gateway 140, Internet interfaces 142 and 152, internet 10, and server computer 110 that includes application programs 111 and database 200. The connection between the portable general wireless device can be wireless, infrared, or optical. (For simplicity throughout, all connections for additional devices have been specified herein as wireless, though such use throughout is recognized as for example purposes only.)

In FIG. 2B, the user's portable WAP wireless device 100 includes the microbrowser 162 that displays control buttons “UP”, “DOWN”, and “SELECT”, to enable the user to navigate through the cards being displayed and to select options that are programmed by the application programs 12. The user's device 100 also includes the wireless application environment (WAE) user agent 166 that renders the content for display on the microbrowser 162. Also included in the user's device 100 is the wireless telephony applications (WTA) user agent 164 that receives compiled WTA files from the WTA server for execution and the WAP protocol stack 112 as discussed below. The user's device 100 includes the user database 20 that stores the user's private data.

The sequence of operational steps carried out by the user's wireless portable WAP wireless device 100 and the server 110 can involve communicating directly through radio transponder 132, wireless network 130, protocol gateway 140, TCP/IP interfaces 142 and 152, internet 10, and server computer 110 that includes application programs 111 and database 200.

Server computer 110 in FIG. 2B includes a database 200, with databases 201, 202, 203, and 204 that are respectively shown in greater detail in FIGS. 4A, 4B, 4C, and 4D.

In FIG. 2B, the protocol gateway 140 includes the WAP protocol stack 112. The WAP protocol stack 112 is organized into five different layers. The application layer is the wireless application environment 114, which executes portable applications and services. The session layer is the wireless session protocol 116, which supplies methods for the organized exchange of content between client/server applications. The transaction layer is the wireless transaction protocol 118, which provides methods for performing reliable transactions. The security layer is wireless transport layer security 122, which provides authentication, privacy, and secure connections between applications. The transport layer is the wireless datagram protocol 124, which shelters the upper layers from the unique requirements of the diverse wireless network protocols, such as CDPD, CDMA, GSM, etc. Additional information about the WAP standard and the WAP protocol stack can be found in the book by Charles Arehart, et al. entitled, “Professional WAP”, published by Wrox Press Ltd., 2000 (ISBN 1-861004-04-1).

The method and system can also be applied to wireless personal digital assistants (PDAs) and wireless telephones implementing the WAP standard. FIG. 2B is a network diagram showing an example relationship between the user's portable WAP wireless device 100, a WAP protocol gateway 140, and the server 110. The user's portable WAP wireless device 100 can be a wireless mobile phone, pager, two-way radio, smartphone, personal communicator, or the like. The user's portable WAP wireless device 100 accesses a small file called a deck that is composed of several smaller pages called cards which are small enough to fit into the display area of the device's microbrowser 162. The small size of the microbrowser 162 and the small file sizes accommodate the low memory constraints of the portable WAP wireless device 100 and the low-bandwidth constraints of a wireless network 130. The cards are written in WML that is specifically devised for small screens and one-hand navigation without a keyboard. The WML language is scaleable from two-line text displays on the microbrowser 162 of a cellular telephone, up through graphic screens found on smartphones and personal communicators. The cards written in the WML language can include programs written in WMLScript, which is similar to JavaScript, but makes minimal demands on memory and CPU power of the device 100 because it does not contain many of the unnecessary functions found in other scripting languages. There are a number of operating systems that support the WAP-enabled wireless device 100, including PalmOS (an operating system from Palm, Inc.), EPOC (an operating system from Psion Software), Windows CE (a version of the Microsoft Windows operating system), OS/9 (an operating system from Microware Systems Corporation), and JavaOS (an operating system from Sun Microsystems, Inc). The user's portable WAP wireless device 100 communicates with a radio transponder 132 and can exchange messages for distances up to several kilometers. The types of wireless networks 130 supported by the WAP standard include Cellular Digital Packet Data (CDPD), Code-Division Multiple Access (CDMA), Global System for Mobile Communications (GSM), Time Division Multiple Access (TDMA), and the like.

The overall process of communication between the user's WAP-enabled wireless device 100, through the WAP protocol gateway 140, to the server 110 resembles the way Web pages are served on the Internet using the HyperText Transfer Protocol (HTTP) or World Wide Web protocol:

[1] The user presses a phone key on the user's device 100 related to the Uniform Resource Locator (URL) of the server 110.

[2] The user's device 100 sends the URL, via the radio transponder 132 and the wireless network 130, to the gateway 140 using WAP protocols.

[3] The gateway 140 translates the WAP request into an HTTP request and sends the translated request over the Internet 10 to the server 110, which runs application programs 111, via the Transmission Control Protocol/Internet Protocol (TCP/IP) interfaces 142 and 152.

[4] The server 110 handles the request in the same manner as any other HTTP request received over the Internet. The server 110 either returns a WML deck or an HTML page back to the gateway 140 using standard server programs written, for example, in Common Gateway Interface (CGI) programs, Java servlets, or the like.

[5] The gateway 140 receives the response from the server 110 on behalf of the user's device 100. If the response is an HTML page, the HTML page is transcoded into WML if necessary, and the WML and WMLScript coding is encoded into a byte code that is then sent to the user's device 100. 0

[6] The user's device 100 receives the response in the WML byte code and displays the first card in the deck on the microbrowser 162 to the user.

Referring to FIG. 3, the network diagram illustrates the relationship between a user's device 100, a server computer 110, and a user's desktop computer 120 as interconnected over a network 10. User's device 100 includes a control program 25, a browser program 30, an operating system program 50, and a network program 60. Network 10 in this embodiment can be the Internet. A useful text describing Internet standards and protocols is the book by D.C. Naik entitled “Internet Standards and Protocols”, Microsoft Press, 1998. The operating system program 50 in user's device 100 and operating system program 50′ in user's desktop computer 120 can be, for example, the Microsoft Windows NT operating system. Details of the Windows NT operating system are described, for example, in the book by M. Brain, entitled “Win 32 System Services”, Prentice Hall, 1996. Browser program 30 in user's device 100 and a browser program 30′ in user's desktop computer 120 can be, for example, the Microsoft Internet Explorer browser program. A detailed description of the Microsoft Internet Explorer browser program is provided in the book by S. Roberts entitled “Programming Microsoft Internet Explorer 5”, Microsoft Press, 1999. The operating system program 80 in server computer 110 can be, for example, Microsoft Windows NT, Red Hat Linux, IBM AIX, or other suitable server computer operating systems. The user's desktop computer 120 also includes network program 60′ and the server computer 110 contains network program 95.

Referring to FIG. 3, server computer 110 includes a storage 175, which includes all of the various types of storage available to server computer 110, including RAM storage, ROM storage, local disk drive storage, remote disk drive storage, and database 200 that includes databases 201, 202, 203, and 204.

FIGS. 4A, 4B, 4C, and 4D illustrate databases in the database 200 of the server computer 110 of FIGS. 2A and 2B. FIG. 4A illustrates the public bookmarks database 201, and, in particular, illustrates the general organization for the database 201. The database 201 includes columns that correspond the HTML site, Preferences, Demographics, WML site, HDML site, cHTML site, and categories (the topics in these columns are representative only and are not intended to be exclusive). The database 201 rows include a number of example websites and respective correlating entries under the appropriate columns. For example, in the first row, the HTML site “www.etrade.com” correlates to average demographics of a “Male, 45 years old living in the Northeast”, the WML site “wap.etrade.com”, the HDML site “wap.etrade.com/hdml”, the cHTML site “etrade.com/chtml (English and Japanese)”, and to the categories “stocks, finance”. Each row continues in FIG. 4A with examples of the correlation of various sample sites.

FIG. 4B is the personal bookmarks database 202 of the user's profile that is organized into multiple columns in the server 110. Each respective user, for example User 1 in FIG. 4B, has a profile. The profile corresponds to the entries or uploads responsive to the questionnaire that the user provided in step 40 of FIG. 1. The profile for a particular user, such as User 1 in FIG. 4B, can include personal bookmarks, demographics, history logs, cookies, and express preferences that the user has uploaded or entered at any time. As a part of an upload process illustrated in step 38 of FIG. 1, the user's desktop computer 120 can supply the history log file and the cookie file from the user's computer 120 to the server 110. This is accomplished either by downloading from the server a Java code program that accesses and transmits back to the server the history log file and the cookie file or, alternatively, the server can expressly request the user to copy the history log file and the cookie file and transmit such to the server. The profile in FIG. 4B can be used by the server to identify other categories of interest of the user that were not expressly provided in the express profile, the questionnaire, or entered or uploaded by the user.

FIG. 4C is a bookmark folder database 203 that illustrates that each user is provided with an individualized folder of bookmarks personalized to that particular user.

FIG. 4D illustrates the express personal bookmarks database 204. FIG. 4D shows the result of the function performed by the server computer 110 in step 40 where the initial set of bookmarks which have the HTML browser format are translated into corresponding formats for the other types of browsers for the devices that the user has specified. For example, if the user has expressly indicated in step 38 of FIG. 1 that the user has bookmarked the www.abcnews.com website, the server computer 110 determines whether a corresponding URL bookmark exists in the server database for the other types of browsers specified by the user. Thus, in this example as shown in FIG. 4D, the indicated categories that correspond to the user's devices are HTML browsers, WML browsers, HDML browsers, and cHTML browsers. The determination of corresponding URLs could be accomplished, for example, by the server computer 110 actually attempting to access website servers on the network using each translated URL as a trial bookmark. Further, the server computer 110 could determine corresponding URLs by acquiring a database of browser sites (for example, WML sites) and then identifying similar sites of another database of browser sites (for example, the HTML sites), and look for similar name or map the name for another. The server computer 110 could also look at overlapping a category directory and just map one category to another (for example, a directory of WAP sites with twenty different on-line trading sites can be mapped with corresponding HTML sites). Alternatively, the trial message can be a query to a web-crawler server that archives URLs in a variety of formats. However, throughout the system and method disclosed herein, the server computer 110 determines corresponding URLs by searching the server databases 200 for corresponding other types of browsers specified by the user. If the trial bookmark, for example wap.abcnews.com, which is a URL for a WML browser exists in the server database, then that particular translated bookmark is entered into the appropriate WML browser category in FIG. 4D. As further shown in FIG. 4D, while the URL can include a traditional WWW address (such as www.cnn.com or www.foxnews.com), the corresponding device URL may consist of a traditional or non-traditional format (such as imode.cnn.com or foxnews.com/hdml, respectively). Alternatively, if a corresponding bookmark for a WML browser does not exist in the server database, then the server can suggest a similar website for the browser specified by the user. Thus, in the example shown in FIG. 4D, www.abcnews.com has a corresponding WML browser, but does not have a corresponding HDML browser and the server has suggested nbcnews.com/hdml for the HDML browser corresponding to the user's specified device. A similar operation is carried out for each respective browser category for all of the information provided in step 38 of FIG. 1. The result of each of the three translated categories of WML browsers, HDML browsers, and cHTML browsers, is shown in FIG. 4D.

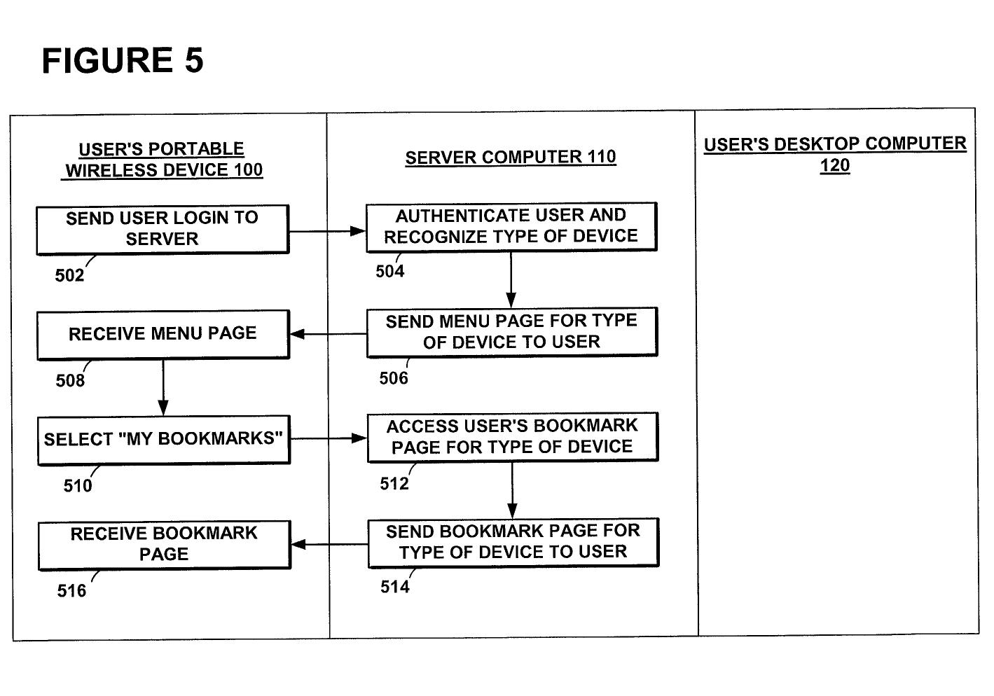

Referring to FIG. 5, a network flow diagram illustrates an example of a sequence of operational steps and interactions between user's device 100, server computer 110, and user's desktop computer 120. FIG. 5 begins with the state in which database 200 in server computer 110 already has stored user's data in databases 201, 202, 203, and 204. Thus, beginning with step 502, user's portable wireless device 100 sends a login request to the server 110. The request formulated and sent by step 502 is a WAP request, in which browser program 30 in user's portable wireless device 100 requests that the server computer 110 authenticate the user and allow the user to login to the system.

Server computer 110 receives the user's request in step 504, extracts the user's identity, typically from the user's URL, from the request, and uses the user's identity and other information to access database 200, and thus appropriate database 201, 202, 203, or 204. Server computer 110 is thus able to authenticate the user. At the same time, the server is able to recognize the type of device with which the user is requesting login.

In step 506, server computer 110 then sends a menu page to user's device 100 that is specifically for the type of device the user is utilizing (e.g., a WML page is sent to a WML device; an HDML page is sent to an HDML device, etc.). The menu page sent to user's device 100 includes a listing of the available options provided by the server 110. In step 508, browser program 30 receives and reads the contents of the menu page, including the information from the user, and displays the contents to the user. Associated with each menu item is a corresponding selection button presented by the browser program 30 on the user's display. The browser program 30 displays the menu page asking the user to select one of the selection buttons corresponding to an available menu item. In this example, the user selects the desired menu item “my bookmarks” at step 510.

In step 512, server computer 110 receives the selected item and accesses database 200 to obtain the selected item. Here, the server computer 110 accesses the user's bookmark page for the type of device that the user logs into the server computer 110 (e.g., the user's WML bookmark database that corresponds to the WML device of the user). Then in step 514, server computer 110 sends the bookmark page, for the type of device of the user, to browser program 30 in user's device 100. The user's device 100 then receives the selected bookmark page at step 516 for display to the user.

Additional description of the principles of request and response systems can be found in a number of books, for example, the book by J. Niederst, “Web Design in a Nutshell”, O'Reilly, 1999.

Referring to FIG. 6A, a functional block diagram of server computer 110 is shown. FIG. 6A shows a memory 602 storing the components of software program objects needed to perform the operations herein.

Memory 602 of server computer 110 is connected by a system bus 604 to a central processor 610 that executes the program instructions stored in memory 602. Bus 604 is also connected to database 200 that includes databases 201, 202, 203, and 204. A TCP/IP network adapter 606 is connected by bus 604 to memory 602, for connecting server computer 110 to network 10. Other disk drives 612 are connected by bus 604 to memory 602.

In FIG. 6A, various functional modules of server computer 110 arranged in an object model are shown. The object model groups the various object oriented software programs into components that perform the major functions and applications in server computer 110. Enterprise Java beans (EJB) is a software component architecture for server computers, which is suitable for embodying the object oriented software program components of FIG. 6A.

A description of E-Commerce server computer programming applications developed with enterprise Java beans is provided in the book by Ed Roman entitled “Mastering Enterprise Java Beans”, John Wiley and Sons, 1999. A description of the use of an object model in the design of a web server computer for E-Commerce applications is provided in the book by Matthew Reynolds entitled “Beginning E-Commerce”, Wrox Press Incorporated, 2000. The components of object oriented software programs in the object model of memory 602 are organized in a business logic tier 614, a presentation tier 615, and an infra-structure objects partition 622.

Business logic tier 614 is further divided into two partitions: an application services objects partition 624 and a data objects partition 626. Infrastructure objects partition 622 includes an object oriented software program component for a database server interface 630, an object oriented software program component for the system administrator interface 632, and an operating system 625. Operating system 625 can be, for example, IBM AIX, Microsoft Windows NT, Red Hat Linux, or the like.

Referring to FIG. 6A, presentation tier 615, which includes a TCP/IP interface 620, is shown. Presentation tier 615 manages the graphical user interface with the visitor at user's device 100.

A suitable implementation for presentation tier 615 can be accomplished with Java servlets to interact with the visitor through HTTP. Java servlets run within a request/response server computer and handle request messages from the visitor and return response messages to the visitor. The Java servlet is a Java object that takes a request as input, parses its data, performs some logic, and then issues a response back to the visitor. Java servlets are pooled and reused to service many visitor requests. TCP/IP interface 620, implemented with Java servlets, functions as a web server computer that communicates with the visitor using the HTTP protocol. TCP/IP interface 620 accepts each HTTP request from the visitor and passes the information in the request to a user visit object 628 in business logic tier 614.

Result information returned from business logic tier 614 is passed by user visit object 628 to TCP/IP interface 620, which sends the results back to the visitor in an HTTP response. TCP/IP interface 620 exchanges data through TCP/IP network adapter 606 to network 10. Java servlets and the development of website server computers is described in the book by Duane K. Fields, et al. entitled “Web Development With Java Server Pages”, Manning Publications Company, 2000.

Business logic tier 614 includes multiples instances of user visit objects 628, 628′, and 628″. Each visitor's user device 100 that sends a message to the server computer 110 has a temporary and separate user visit object 628 instantiated to represent the visit. The Enterprise Java Bean server computer can instantiate multiple copies of user visit object 628 in business logic tier 614 to handle multiple messages from multiple visitors.

Each user visit object 628, 628′, and 628″ will buffer visitor-specific information and maintain a visitor-specific state for the duration of the session with the visitor. Each user visit object 628 is a stateful session bean that will hold the conversational state about the visitor's visit. A stateful session bean is an Enterprise Java Bean that services business processes that span multiple method requests or transactions. Each stateful session bean retains a state on behalf of an individual visitor. Data received by server computer 110 from user's device 100, and data sent by server computer 110 to the visitor will be temporarily buffered in the user visit object 628.

Each user visit object 628 receives, from TCP/IP interface 620, the visitor data sent by user device 100 to server computer 110. Each user visit object 628 will also buffer the resulting information that is computed by server computer 110. This information is then passed back to TCP/IP interface 620.

When a message from user's device 100 arrives, shown in step 702 of FIG. 6B, and is received by TCP/IP interface 620, shown in FIG. 6A, a user visit object 628 is instantiated and the received data is passed to user visit object 628. Depending on the state of the transaction, shown in FIG. 6B, user visit object 628 will send the method call to one of the object oriented software program components in application services object partition 624 of server computer 110, shown in FIG. 6A. If a transaction is at step 706 in FIG. 6B, then a “selected action equals PROFILE” message has been received.

User visit object 628 will then send a method call to a “CREATE/UPDATE USER PROFILE” application 640, shown in FIG. 6A and in step 706 in FIG. 6B. Profile application method 640 will then access data via a “PROFILE” data object 660, shown in FIG. 6A. User visit object 628 will then pass the result data back to TCP/IP interface 620, which will send the result data back to user's device 100.

Enterprise Java Beans support transaction processing, where a series of small operations are executed as one large atomic operation. This allows multiple instantiations of user visit object 628, representing multiple visitors, to invoke the same resource component, such as “PROFILE” application 640. When multiple calls are made on a method of the same resource component, the invocations are serialized and performed in lock step. Any access to databases 200, 201, 202, 203, and 204 will be handled through database server interface 630.

Similarly, if the state of the transaction is at step 710 in a FIG. 6B, then a “selected action equals PERSONAL BOOKMARK” message has been received. User visit object 628 will then send a method call to the “PERSONAL BOOKMARK database management” application 642 in FIG. 6A. The “PERSONAL BOOKMARK DATABASE MANAGEMENT” application 642 will access data via a “PERSONAL BOOKMARK” data object 662 in FIG. 6A. User visit object 628 will then pass the result data to TCP/IP interface 620, which will send the data back to user's device 100.

Alternatively, if the state of the transaction is at step 714 of FIG. 6B, then a “selected action equals PUBLIC BOOKMARK” message has been received at central processor 610. User visit object 628 will then send a method call “PUBLIC BOOKMARK DATABASE MANAGEMENT” application 644. The Public Bookmark Database Management application method 644 will access data from PUBLIC BOOKMARK data object 664 in FIG. 6A. User visit object 628 will pass the result data back to TCP/IP interface 620, which will send the interest page information back to user's device 100.

Alternatively, if the state of the transaction is at step 718 in FIG. 6B, a “selected action equals CATEGORY” message has been received by server computer 110. User visit object 628 will then send a method call to the “BOOKMARK CATEGORY TRANSFER” application method 646. The “BOOKMARK CATEGORY TRANSFER” application method 646 will access data via a CATEGORY data object 666 in FIG. 6A. User visit object 628 will then pass the result data back to TCP/IP interface 620 that will send the result data back to user's device 100.

Alternatively, if the state of the transaction is at step 722 in FIG. 6B, a “selected action equals DEVICE TYPE” message has been received by server computer 110. User visit object 628 will then send a method call to the “DEVICE TYPE” application method 648. The “DEVICE TYPE” application method 648 will access data via a DEVICE TYPE data object 668 in FIG. 6A. User visit object 628 will then pass the result data back to TCP/IP interface 620 that will send result data back to user's device 100.

Alternatively, if the state of the transaction is at step 726 in FIG. 6B, a “selected action equals SUGGESTED” message has been received by server computer 110. User visit object 628 will then send a method call to the “SUGGESTED BOOKMARK TRANSFER” application method 650. The “SUGGESTED BOOKMARK TRANSFER” application method 650 will access data via a SUGGESTED data object 670 in FIG. 6A. User visit object 628 will then pass the result data back to TCP/IP interface 620 that will send the result data back to user's device 100.

Referring to FIG. 6B, a flow diagram shows a user visit object method 628. The method begins with step 702 receiving a user's browser request. The method passes to step 704, which decides whether a “selected action equals PROFILE” message has been received. If it has been received, then the process flows to step 706 that sends a method call to PROFILE application 640. Alternatively, the method passes to step 708, which determines whether a “selected action equals PERSONAL BOOKMARK” message has been received. If it has been received, the method flows to step 710, which sends a method call to “PERSONAL BOOKMARK” application 642. If it has not been received, then the process flows to step 712, which determines whether the “selected action equals PUBLIC BOOKMARK” message has been received. If it has been received, the process flows to step 714, which sends a method call to a “PUBLIC BOOKMARK” application 644. If it has not been received, the process flows to step 716, which determines whether the “selected action equals CATEGORY” message has been received. If it has been received, the process flows to step 718, which sends a method call to a “CATEGORY” application 646. If it has not been received, the process flows to step 720, which determines whether the “selected action equals DEVICE TYPE” message has been received. If it has been received, the process flows to step 722, which sends a method call to a “DEVICE TYPE” application 648. If it has not been received, then the process flows to step 724, which determines whether the “selected action equals SUGGESTED” message has been received. If it has been received, the method flows to step 726, which sends a method call to a “SUGGESTED” application 650. If it has not been received, the process flows to step 728, which sends a request to a parser for additional processing.

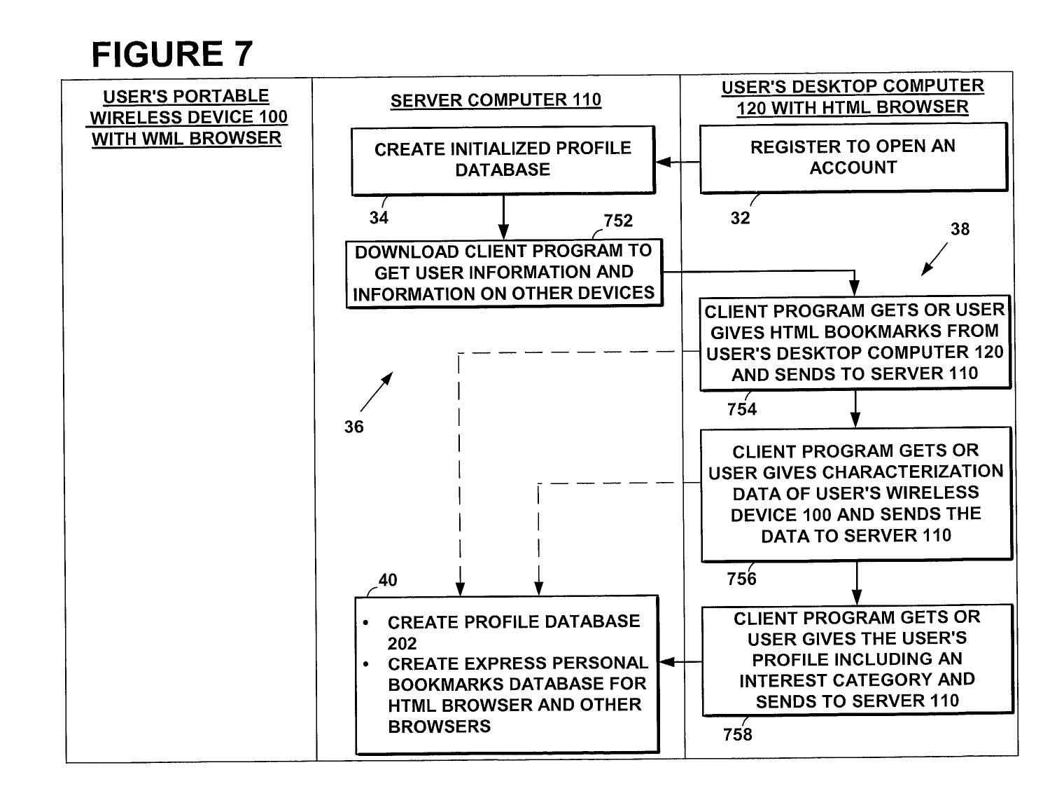

Steps 36, 38, and 40 of FIG. 1 are shown in greater detail in FIG. 7. Client program software is downloaded over the Internet from the server 110 to the user's desktop computer 120. The client program software is able to upload bookmarks, user profiles, and/or characterization information on other devices as provided by the user or as desired or required by the server. In FIG. 7, step 752 is a more detailed description of step 36 in FIG. 1, in which the server 110 downloads the client program to the user's desktop computer 120 to get user information and information on other devices. After installation on the user's desktop computer 120, the client program carries out step 38 of FIG. 1, by performing the more detailed, programmed steps 754, 756, and/or 758 in FIG. 7. In step 754, the client program gets or the user gives HTML bookmarks from user's desktop computer 120 and sends them to server 110. In step 756, the client program gets or the user gives characterization data of the user's wireless device 100 from the user's desktop computer 120 and sends the data to server 110. In step 758, the client program gets or the user gives the user's profile including interest data from the user's desktop computer 120 and sends to server 110. Any of steps 754, 756, or 758 can be performed as necessary. Then, step 40 creates the profile database 202 in the server 110 and creates the express personal bookmarks database for the HTML browser and for the other specified browsers.

The present system and method has been illustrated and described with respect to specific embodiments and applications thereof. To facilitate discussion, a preferred embodiment is assumed, however, that the above-described embodiments are merely illustrative of the principles herein and are not intended to be exclusive embodiments thereof. It should be understood by one skilled in the art that alternative embodiments drawn to variations in the enumerated embodiments and teachings disclosed herein can be derived and implemented to realize the various benefits herein.

It should further be understood that the foregoing and many various modifications, omissions, and additions may be devised by one skilled in the art without departing from the spirit and scope of the system and method. It is therefore intended that the present system and method is not limited to the disclosed embodiments but should be defined in accordance with the following claims.

I claim:

1. A method for managing network address bookmarks for a variety of browser types in computers in a network, comprising:
receiving a first network address bookmark at a server, from a first computer having a first type browser, the first bookmark having a first format suitable for the first type browser;
receiving a characterization at the server of a second computer having a second type browser;
translating the first bookmark at the server into a second network address bookmark having a second format suitable for the second type browser; and

2. The method of claim 1, further comprising:
sending the second bookmark to the second computer.

3. The method of claim 1, wherein the first type browser is different from the second browser type.

4. The method of claim 1, wherein the translating step further comprises:
transmitting a trial message on the network from the server using the second network address bookmark;
receiving at the server a response to the transmitting step from the network; and
determining from the response whether the second network address exists in the network.

5. The method of claim 1, wherein the translating step further comprises:
searching a database of candidate bookmarks for the second network address bookmark; and
determining from results of the searching step whether the second bookmark is valid.

6. A method for managing network address bookmarks at a server for a user at a computer in a network, comprising:
receiving, from a user at a computer, a first network address bookmark at a server, the first bookmark having an interest category;
accessing with the server a database of candidate bookmarks associated with the interest category;
forming a list of a portion of the candidate bookmarks obtained from the accessing step; and
sending the list of bookmarks to the computer.

7. A method for managing network address bookmarks at a server for a user at a computer in a network, comprising:
receiving a first user profile at a server, from a first user at a first computer, the first user profile including an interest category;
accessing with the server a database of candidate bookmarks associated with the interest category;
forming a list including a portion of the candidate bookmarks obtained from the accessing step, and
sending the list of bookmarks to the computer.

8. The method of claim 7, wherein the first user profile includes a history log of the computer, the method further comprising the steps of:
determining from the history log a second interest category;
accessing with the server a database of candidate bookmarks associated with the second interest category;
augmenting the list with a portion of the candidate bookmarks obtained from the accessing step, and
sending the augmented list of bookmarks to the computer.

9. The method of claim 7, wherein the first user profile includes browser cookie data of the computer, the method further comprising the steps of:
determining from the browser cookie data a second interest category;
accessing with the server a database of candidate bookmarks associated with the second interest category;
augmenting the list with a portion of the candidate bookmarks obtained from the accessing step, and
sending the augmented list of bookmarks to the computer.

10. The method of claim 7, wherein the first user profile includes demographic data of the user, the method further comprising the steps of:
determining from the demographic data a second interest category;
accessing with the server a database of candidate bookmarks associated with the second interest category;
augmenting the list with a portion of the candidate bookmarks obtained from the accessing step, and
sending the augmented list of bookmarks to the computer.

11. A method for managing network address bookmarks for a variety of browser types in computers in a network, comprising:
receiving, at a server from a first computer, interest data having a first format;
receiving a characterization at the server of a second computer having a second format;
compiling a first set of bookmarks in the first format based upon the interest data; and
compiling a second set of bookmarks in the second format based upon the first set of bookmarks.

12. The method of claim 11 further comprising:
sending the second set of bookmarks to the second computer.

13. The method of claim 11 wherein the interest data includes a list of bookmarks, a history file, a cookie file, demographic information, or express preference information.

14. A method for managing network address bookmarks for a variety of browser types in computers in a network, comprising:
receiving, at a server from a first computer, interest data having a first format compatible with the first computer;
receiving a characterization at the server of a second format compatible with a second computer;
accessing a database containing bookmarks having the first format and retrieving a first bookmark based upon the interest data; and
translating the first bookmark into a second bookmark in the second format.

15. The method of claim 14 further comprising:
sending the second bookmark to the second computer.

16. The method of claim 14 wherein the interest data includes a list of bookmarks, a history file, a cookie file, demographic information, or express preference information.

17. The method of claim 14 wherein the characterization of the second format compatible with a second computer is a browser type in the second computer.

18. A method for managing network address bookmarks for a variety of browser types in computers in a network, comprising:
receiving, at a server from a first computer, interest data having a first format compatible with the first computer;
receiving a characterization at the server of a second format compatible with a second computer;
accessing a first database containing bookmarks having the first format and retrieving a first bookmark based upon the interest data;
accessing a second database containing bookmarks having the second format; and
selecting a bookmark from the second bookmarks, wherein the selected bookmark is based upon the interest data.

19. The method of claim 18 further comprising:
sending the selected bookmark to the second computer.

20. The method of claim 18 wherein the interest data includes a list of bookmarks, a history file, a cookie file, demographic information, or express preference information.

21. The method of claim 18 wherein the characterization of a second format compatible with a second computer is a browser type in the second computer.

22. A system for managing network address bookmarks for a variety of browser types in computers in a network, comprising:
means for receiving:
a first network address bookmark from a first computer having a first type browser, the first bookmark having a first format suitable for the first type browser; and
a characterization of a second computer having a second type browser;
means for translating the first bookmark into a second network address bookmark having a second format suitable for the second type browser; and
means for sending the second bookmark to the second computer.

23. A system for managing network address bookmarks for a variety of browser types in computers in a network, comprising:
a processor;
a memory coupled to the processor;
said memory storing:
a first network address bookmark received from a first computer having a first type browser, the first bookmark having a first format suitable for the first type browser; and
a characterization received of a second computer having a second type browser;
wherein the first bookmark is translated by the processor into a second network address bookmark having a second format suitable for the second type browser; and
wherein the second bookmark is sent by the processor to the second computer.

24. A system for managing network address bookmarks for a variety of browser types in computers in a network, comprising:
a processor;
a memory coupled to the processor;
said memory storing:
interest data from a first computer, the interest data having a first format; and
a characterization of a second computer having a second format;
wherein a first set of bookmarks in the first format is compiled based upon the interest data; and
wherein a second set of bookmarks in the second format is compiled based upon the first set of bookmarks.

25. The system of claim 24 wherein the second set of bookmarks is sent to the second computer.

26. The system of claim 24 wherein the interest data includes a list of bookmarks, a history file, a cookie file, demographic information, or express preference information.

27. A system for managing network address bookmarks for a variety of browser types in computers in a network, comprising:
a processor;
a memory coupled to the processor;
said memory storing:
interest data having a first format compatible with a first computer;
a characterization of a second format compatible with a second computer;
wherein a first database containing bookmarks having the first format is accessed and wherein the bookmarks include a first bookmark based upon the interest data; and
wherein a first bookmark is translated into a second bookmark in the second format.

28. The system of claim 27 wherein the selected bookmark is sent to the second computer.

29. The system of claim 27 wherein the interest data includes a list of bookmarks, a history file, a cookie file, demographic information, or express preference information.

30. The system of claim 27 wherein the characterization of a second format compatible with a second computer is a browser type in the second computer.

31. Computer executable program code stored on a computer readable medium, the code for managing network address bookmarks in a server for a variety of browser types in computers in a network, comprising:
code to receive a first network address bookmark from a first computer having a first type browser, the first bookmark having a first format suitable for the first type browser;
code to receive a characterization of a second computer having a second type browser;
code to translate the first bookmark into a second network address bookmark having a second format suitable for the second type browser; and
code to send the second bookmark to the second computer.

32. Computer executable program code stored on a computer readable medium, the code for managing network address bookmarks in a server for a variety of browser types in computers in a network, comprising:
code to receive, from a first computer, interest data having a first format;
code to receive a characterization of a second computer having a second format;
code to compile a first set of bookmarks in the first format based upon the interest data; and
code to compile a second set of bookmarks in the second format based upon the first set of bookmarks.

33. Computer executable program code stored on a computer readable medium, the code for managing network address bookmarks in a server for a variety of browser types in computers in a network, comprising:
code to receive, from a first computer, interest data having a first format compatible with the first computer;
code to receive a characterization of a second format compatible with a second computer;
code to access a first database containing bookmarks having the first format and retrieving a first bookmark based upon the interest data;
code to access a second database containing bookmarks having the second format; and
code to select a bookmark from the second bookmarks, wherein the selected bookmark is based upon the interest data.

34. A computer readable medium having computer executable program code stored thereon, the code for managing network address bookmarks in a server for a variety of browser types in computers in a network, comprising:
code to receive a first network address bookmark from a first computer having a first type browser, the first bookmark having a first format suitable for the first type browser;
code to receive a characterization of a second computer having a second type browser;
code to translate the first bookmark into a second network address bookmark having a second format suitable for the second type browser; and
code to send the second bookmark to the second computer.

35. A computer readable medium having computer executable program code stored thereon, the code for managing network address bookmarks in a server for a variety of browser types in computers in a network, comprising:
code to receive, from a first computer, interest data having a first format;
code to receive a characterization of a second computer having a second format;
code to compile a first set of bookmarks in the first format based upon the interest data; and
code to compile a second set of bookmarks in the second format based upon the first set of bookmarks.

36. A computer readable medium having computer executable program code stored thereon, the code for managing network address bookmarks in a server for a variety of browser types in computers in a network, comprising:
code to receive, from a first computer, interest data having a first format compatible with the first computer;
code to receive a characterization of a second format compatible with a second computer;
code to access a first database containing bookmarks having the first format and retrieving a first bookmark based upon the interest data;
code to access a second database containing bookmarks having the second format; and
code to select a bookmark from the second bookmarks, wherein the selected bookmark is based upon the interest data.

37. A programmed computer for managing network address bookmarks for a variety of browser types in computers in a network, comprising:
a memory for storing computer executable code; and
a processor for executing the program code stored in memory, wherein the program code includes:
code to receive a first network address bookmark from a first computer having a first type browser, the first bookmark having a first format suitable for the first type browser;
code to receive a characterization of a second computer having a second type browser;
code to translate the first bookmark into a second network address bookmark having a second format suitable for the second type browser; and
code to send the second bookmark to the second computer.

38. A programmed computer for managing network address bookmarks for a variety of browser types in computers in a network, comprising:
a memory for storing computer executable code; and
a processor for executing the program code stored in memory, wherein the program code includes:
code to receive, from a first computer, interest data having a first format;
code to receive a characterization of a second computer having a second format;
code to compile a first set of bookmarks in the first format based upon the interest data; and
code to compile a second set of bookmarks in the second format based upon the first set of bookmarks.

39. A programmed computer for managing network address bookmarks for a variety of browser types in computers in a network, comprising:
a memory for storing computer executable code; and
a processor for executing the program code stored in memory, wherein the program code includes:
code to receive, from a first computer, interest data having a first format compatible with the first computer;
code to receive a characterization of a second format compatible with a second computer;
code to access a first database containing bookmarks having the first format and retrieving a first bookmark based upon the interest data;
code to access a second database containing bookmarks having the second format; and
code to select a bookmark from the second bookmarks, wherein the selected bookmark is based upon the interest data.

40. Computer executable program code stored on a computer readable medium, the code for requesting by a first computer having a first type browser, network address bookmarks for a variety of browser types in computers in a network, comprising:
code to send a first network address bookmark from the first computer to a server, the first bookmark having a first format suitable for the first type browser;
code to send a characterization to the server of a second computer having a second type browser;
code to cause the server to translate the first bookmark into a second network address bookmark having a second format suitable for the second type browser; and
code to cause the server to send the second bookmark to the second computer.

41. Computer executable program code stored on a computer readable medium, the code for requesting by a first computer having a first type browser, network address bookmarks for a variety of browser types in computers in a network, comprising:
code to send a first user profile from the first computer to a server, the first user profile including an interest category;
code to cause the server to access a database of candidate bookmarks associated with the interest category, form a list including a portion of the candidate bookmarks obtained from the accessing step, and send the list of bookmarks to the first computer.
